(19) United States
(12) Patent Application Publication
(10) Pub. No.: US 2019/0226440 A1
(43) Pub. Date: Jul. 25, 2019

(54) DRIVING SYSTEM AND DRIVING METHOD FOR VEHICLE

(71) Applicant: TOYOTA JIDOSHA KABUSHIKI KAISHA, Toyota-shi (JP)

(72) Inventor: Koji MURAKAMI, Toyota-shi (JP)

(73) Assignee: TOYOTA JIDOSHA KABUSHIKI KAISHA, Toyota-shi (JP)

(21) Appl. No.: 16/204,201

(22) Filed: Nov. 29, 2018

(30) Foreign Application Priority Data
Jan. 19, 2018 (JP) 2018-007260

(51) Int. Cl. F02N 19/00

(52) U.S. Cl. CPC F02N 19/005; F02N 11/08

(57) ABSTRACT

When an engine is stopped, a rotational position at a time when a crankshaft starts rotating in a reverse direction is predicted based on a rotational position detected by a crank angle sensor. A target rotational position is set within a range of the crankshaft rotational position between a time when the exhaust valve of one of four cylinders in the expansion stroke when the crankshaft starts rotating in the reverse direction is opened and a time when the expansion stroke of the cylinder ends. When the predicted rotational position is behind the target rotational position, a torque applying device applies a positive rotational torque to the crankshaft. At the time when the exhaust valve of the cylinder in the expansion stroke when the crankshaft starts rotating in the reverse direction is opened, application of the positive rotational torque from the torque applying device to the crankshaft is stopped.

### BACKGROUND

The present disclosure relates to a driving system and a driving method for a vehicle.

The driving system for a vehicle disclosed in Japanese Laid-Open Patent Publication No. 2016-200007 includes an engine and a motor generator drivably coupled to the engine. The driving system disclosed in the above document further includes an engine stop controlling device that controls the rotational position of the crankshaft when the engine is stopped. The engine stop controlling device disclosed in the above document predicts the behavior of the rotational position (rotational speed) of the crankshaft being stopped according to a predetermined computational expression when the engine stop controlling device receives an engine stop request. The engine stop controlling device controls the torque transmitted from the motor generator to the engine so that the predicted behavior of the rotational position of the crankshaft agrees with a target behavior. In this way, when the engine is stopped, the position at which the crankshaft is stopped is caused to agree with a target stop position. The target stop position is determined in advance as a rotational position at which, when the engine is restarted, the energy produced by fuel combustion can be efficiently converted into rotation of the crankshaft.

### SUMMARY

As the engine varies with time, the behavior of the rotational position of the crankshaft can also vary. For example, the friction loss at the time of activation of the engine can vary with the degree of wear of each member (such as a piston) forming the engine or the amount of deposit on the surface of each member. If the behavior of the rotational position of the crankshaft varies with time, it can be difficult to ensure that the behavior of the rotational position of the crankshaft is accurately predicted according to a preset computational expression, map or the like. As a result, it can be difficult to make the rotational position of the crankshaft agree with the target stop position when the engine is stopped.

Examples of the present disclosure will now be described.

### Example 1

A driving system for a vehicle is provided that includes an engine having four cylinders, a torque applying device configured to be capable of applying a positive rotational torque to a crankshaft of the engine, a crank angle sensor configured to detect a rotational position of the crankshaft, and an engine stop controlling device configured to control the rotational position of the crankshaft when the engine is stopped. The engine stop controlling device includes a rotational position prediction section and an application torque control section. The rotational position prediction section is configured to predict a predicted rotational position based on the rotational position detected by the crank angle sensor when the engine is stopped. The predicted rotational position is a rotational position of the crankshaft at a time when the crankshaft starts rotating in a reverse direction. The application torque control section is configured to control the torque applying device to apply a positive rotational torque to the crankshaft when the predicted rotational position is behind a target rotational position. The target rotational position is set within a range of the rotational position of the crankshaft between a time when an exhaust valve of one of the four cylinders that is in an expansion stroke when the crankshaft starts rotating in the reverse direction is opened and a time when the expansion stroke of the cylinder ends. The application torque control section is configured to stop application of the positive rotational torque from the torque applying device to the crankshaft at the time when the exhaust valve of the cylinder that is in the expansion stroke when the crankshaft starts rotating in the reverse direction is opened.

In the configuration described above, when the engine is stopped, the target rotational position is set within the range of the rotational position of the crankshaft between the time when the exhaust valve of the cylinder that is in the expansion stroke when the crankshaft starts rotating in the reverse direction is opened and the time when the expansion stroke of the cylinder ends. If the predicted rotational position of the crankshaft is behind the target rotational position, a positive rotational torque is applied to the crankshaft. Therefore, the crankshaft rotates beyond the predicted rotational position.

Furthermore, in the configuration described above, application of the positive rotational torque to the crankshaft is stopped at the time when the exhaust valve of the cylinder that is in the expansion stroke when the crankshaft starts rotating in the reverse direction is opened. Even though application of the positive rotational torque is stopped, the crankshaft slightly rotates by inertia. In contrast, in the cylinder that is in the compression stroke when the crankshaft starts rotating in the reverse direction, a reaction force of the compressed air in the cylinder occurs. Therefore, the crankshaft is unlikely to get over the top dead center of the cylinder that is in the compression stroke when the crankshaft starts rotating in the reverse direction. The crankshaft rotates in the reverse direction under the reaction force of the air in the cylinder that is in the compression stroke when the crankshaft starts rotating in the reverse direction. As a result, the crankshaft stops rotating in the close vicinity of the rotational position at which the exhaust valve of the cylinder that is in the expansion stroke when the crankshaft starts rotating in the reverse direction is opened. The stop position of the crankshaft is close to the rotational position at which the torque required to start the engine is at the minimum.

The time to stop the application of the positive rotational torque to the crankshaft is determined based on the actual rotational position of the crankshaft detected. Therefore, even if the behavior of the rotation of the crankshaft slightly varies with the engine varying with time, a large error in stop position of the crankshaft is prevented.

### Example 2

A driving system for a vehicle is provided that includes an engine having four cylinders, a torque applying device configured to be capable of applying a negative rotational torque to a crankshaft of the engine, a crank angle sensor configured to detect a rotational position of the crankshaft, and an engine stop controlling device configured to control the rotational position of the crankshaft when the engine is stopped. The engine stop controlling device includes a rotational position prediction section and an application torque control section. The rotational position prediction section is configured to predict a predicted rotational position based on the rotational position detected by the crank angle sensor when the engine is stopped. The predicted rotational position is a rotational position of the crankshaft at a time when the crankshaft starts rotating in a reverse direction. The application torque control section is configured to control the torque applying device to apply a negative rotational torque to the crankshaft when the predicted rotational position is beyond a target rotational position. The target rotational position is set within a range of the rotational position of the crankshaft between a time when an exhaust valve of one of the four cylinders that is in an expansion stroke when the crankshaft starts rotating in the reverse direction is opened and a time when the expansion stroke of the cylinder ends. The application torque control section is configured to stop application of the negative rotational torque from the torque applying device to the crankshaft when the crankshaft starts rotating in the reverse direction.

In the configuration described above, the target rotational position is set within the range of the rotational position of the crankshaft between the time when the exhaust valve of the cylinder that is in the expansion stroke when the crankshaft starts rotating in the reverse direction is opened and the time when the expansion stroke of the cylinder ends. If the predicted rotational position of the crankshaft is beyond the target rotational position, a negative rotational torque is applied to the crankshaft. Therefore, the crankshaft is prevented from rotating largely beyond the target rotational position.

Furthermore, in the configuration described above, application of the negative rotational torque to the crankshaft is stopped when the crankshaft starts rotating in the reverse direction. Even though application of the negative rotational torque is stopped, in the cylinder that is in the compression stroke when the crankshaft starts rotating in the reverse direction, a reaction force of the compressed air in the cylinder occurs. Therefore, the crankshaft slightly rotates in the reverse direction under the reaction force that occurs in the cylinder that is in the compression stroke when the crankshaft starts rotating in the reverse direction even after application of the negative rotational torque is stopped. As a result, the crankshaft stops rotating in the close vicinity of the rotational position at which the exhaust valve of the cylinder that is in the expansion stroke when the crankshaft starts rotating in the reverse direction, which is behind the target rotational position is opened. The stop position of the crankshaft is close to the rotational position at which the torque required to start the engine is at the minimum.

The time to stop the application of the negative rotational torque to the crankshaft is determined based on the actual rotational position of the crankshaft detected. Therefore, even if the behavior of the rotation of the crankshaft slightly varies with the engine varying with time, a large error in stop position of the crankshaft is prevented.

### Example 3

In the driving system for a vehicle of Example 1 or 2, the torque applying device includes a motor generator that is drivably coupled to the engine. The motor generator is configured to be driven by a rotational torque from the engine and generate electricity and to be supplied with electric power form a battery and apply a rotational torque to the engine. The torque applying device is configured to control the motor generator to apply a positive rotational torque to the engine when the engine in a stopped state is started.

According to the configuration described above, the magnitude of the rotational torque applied to the crankshaft when stopping the engine can be relatively accurately controlled by the motor generator. In addition, when the rotational speed (number of rotations) of the crankshaft is low, the rotational torque applied by the motor generator to the engine is not as high as the rotational torque applied by the starter, which is commonly used to start the engine, for example. In the configuration in which the motor generator is used to start the engine, it is highly preferable to apply the control of the stop position of the crankshaft to reduce the rotational torque required to start the engine, in order to ensure that the engine is started with higher reliability.

### Example 4

A driving method for a vehicle is provided that performs the various processes described in Example 1.

### Example 5

A driving method for a vehicle is provided that performs the various processes described in Example 2.

### Example 6

A non-transitory computer readable memory medium is provided that stores a program that causes a processing device to perform the various processes described in Example 1.

### Example 7

A non-transitory computer readable memory medium is provided that stores a program that causes a processing device to perform the various processes described in Example 2.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a configuration of a hybrid system according to an embodiment of the present disclosure;

FIG. 2 is a diagram showing a relationship between a stop position of the crankshaft and a required starting torque to start the engine in the hybrid system shown in FIG. 1;

FIG. 3 is a flowchart showing an engine stop controlling process in the hybrid system shown in FIG. 1;

FIG. 4 is a diagram showing a relationship between strokes of combustion cycles of the four cylinders in the hybrid system shown in FIG. 1; and

FIG. 5 is a diagram showing a relationship between an engine rotational speed and an application torque in the hybrid system shown in FIG. 1.

### DETAILED DESCRIPTION

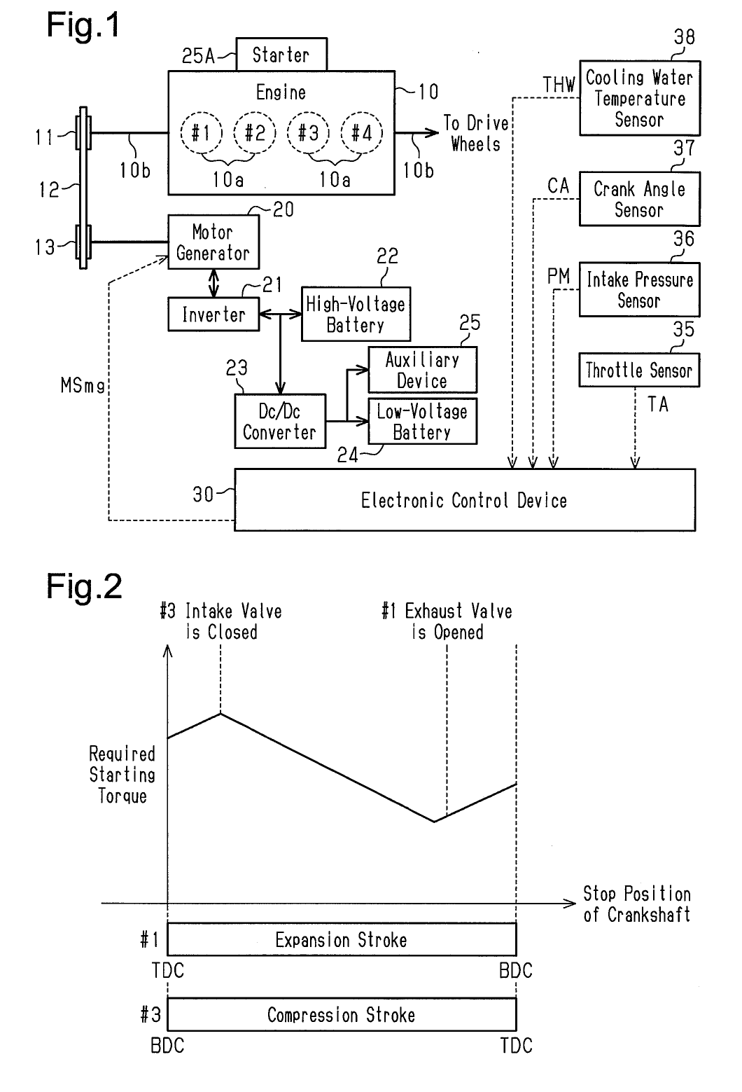

In the following, an embodiment of the present disclosure will be described. First, with reference to FIG. 1, a schematic configuration of a hybrid system as a driving system for a vehicle will be described.

As shown in FIG. 1, the hybrid system includes an engine 10 as a driving source. In the engine 10, four cylinders 10a are arranged side by side. Provided that the four cylinders 10a of the engine 10 are denoted as first to fourth cylinders 10a from one side (left in FIG. 1) of the arrangement, fuel addition and combustion occur in the following order: the first cylinder 10a, the second cylinder 10a, the third cylinder 10a, and then the fourth cylinder 10a. Provided that a process from the beginning of an intake stroke of the cylinder 10a to the end of an exhaust stroke of the same including a compression stroke and an expansion stroke (combustion stroke) of the same is designated as one combustion cycle (720 CA), the combustion cycles of the cylinders 10a are shifted by one fourth of a cycle (180 CA). Furthermore, in this embodiment, as a mechanism that opens and closes an exhaust valve and an intake valve of the engine 10, the variable valve timing mechanism is employed. Therefore, the timings of opening and closing of the exhaust valve and the intake valve of the cylinder 10a can be changed within a predetermined range.

A crankshaft 10b of the engine 10 is drivably coupled to the drive wheels via a transmission or the like (not shown). The crankshaft 10b of the engine 10 is also drivably coupled to a first pulley 11. A transmission belt 12 is looped over the first pulley 11. Although not shown, the crankshaft 10b of the engine 10 is drivably coupled to a pump that produces hydraulic pressure, the compressor of the air conditioner or the like via a belt, a pulley, a chain or the like.

The hybrid system includes a motor generator 20 as another driving source in addition to the engine 10. The motor generator 20 is a so-called three-phase alternating-current motor. The output shaft of the motor generator 20 is drivably coupled to a second pulley 13, and a transmission belt 12 is looped over the second pulley 13. That is, the motor generator 20 is drivably coupled to the engine 10 via the second pulley 13, the transmission belt 12 and the first pulley 11. When the motor generator 20 operates as an electric motor, the motor generator 20 applies a rotational torque to the second pulley 13, and the rotational torque is input to the crankshaft 10b of the engine 10 via the transmission belt 12 and the first pulley 11. That is, in this case, the motor generator 20 applies a positive rotational torque to the crankshaft 10b, thereby assisting the engine 10 to drive the vehicle. In contrast, when the motor generator 20 operates as a generator, a rotational torque of the crankshaft 10b of the engine 10 is input to the output shaft of the motor generator 20 via the first pulley 11, the transmission belt 12 and the second pulley 13. The motor generator 20 generates electricity as the output shaft rotates. That is, in this case, the motor generator 20 applies a negative rotational torque to the crankshaft 10b of the engine 10. As described above, the motor generator 20 operates as a torque applying device capable of applying a rotational torque to the crankshaft 10b of the engine 10.

A high-voltage battery 22 is connected to the motor generator 20 via an inverter 21. The inverter 21 is a so-called bidirectional inverter. The inverter 21 converts an alternating-current voltage generated by the motor generator 20 into a direct-current voltage and outputs the direct-current voltage to the high-voltage battery 22. In addition, the inverter 21 converts a direct-current voltage output from the high-voltage battery 22 into an alternating-current voltage and outputs the alternating-current voltage to the motor generator 20. Although the inverter 21 is shown as being separate from the motor generator 20 in FIG. 1, the inverter 21 may be incorporated in the housing of the motor generator 20.

The high-voltage battery 22 is a 48 V lithium ion battery. The high-voltage battery 22 supplies electric power to the motor generator 20 when the motor generator 20 operates as an electric motor. The high-voltage battery 22 is charged with electric power supplied from the motor generator 20 when the motor generator 20 operates as a generator.

A DC/DC converter 23 is connected to the motor generator 20 via the inverter 21. The DC/DC converter 23 is also connected to the high-voltage battery 22. The DC/DC converter 23 reduces the direct-current voltage output from the inverter 21 or the high-voltage battery 22 to a voltage of 12 V to 15 V and outputs the reduced voltage. A low-voltage battery 24 is connected to the DC/DC converter 23.

The low-voltage battery 24 is a 12 V lead-acid battery that provides a lower voltage than the high-voltage battery 22. The low-voltage battery 24 outputs a direct-current voltage of 12 V when the DC/DC converter 23 is not operating or when the output voltage of the DC/DC converter 23 is 12 V. The low-voltage battery 24 is charged with electric power supplied from the DC/DC converter 23 when the output voltage of the DC/DC converter 23 is higher than an open circuit voltage (OCV) of the low-voltage battery 24.

Various auxiliary devices 25 are connected to the DC/DC converter 23 and the low-voltage battery 24. Examples of the auxiliary devices 25 include lighting equipment of the vehicle, such as headlights, direction indicators, and an interior light, or interior equipment of the vehicle, such as a car navigation system or speakers. The auxiliary device 25 receives electric power from the low-voltage battery 24 when the DC/DC converter 23 is not operating. The auxiliary device 25 receives electric power from the DC/DC converter 23 when the output voltage of the DC/DC converter 23 is higher than the open circuit voltage (OCV) of the low-voltage battery 24.

As one of the auxiliary devices 25 described above, a starter 25A that starts the engine 10 is connected to the DC/DC converter 23 and the low-voltage battery 24. The starter 25A is a direct-current motor, and the output shaft of the starter 25A is drivably coupled to the crankshaft 10b of the engine 10. The starter 25A is driven by electric power supplied from the low-voltage battery 24 or the DC/DC converter 23.

The hybrid system includes an electronic control device (ECU) 30 that controls application of a rotational torque to the crankshaft 10b of the engine 10 by the motor generator 20. The electronic control device 30 is a processing circuit (computer) that includes a computing section that executes various programs (applications), a nonvolatile storage section that stores programs or the like, and a volatile memory that temporarily stores data during execution of programs, for example.

The electronic control device 30 receives signals indicating the state of the engine 10 from various sensors or the like mounted on the vehicle. More specifically, the electronic control device 30 receives a signal indicating a throttle opening TA from a throttle sensor 35, which detects the opening of a throttle valve. The throttle valve is a valve that is provided in an intake channel of the engine 10 and adjusts an intake air flow rate. The throttle opening TA detected is 100% when the throttle valve is fully open and 0% when the throttle valve is fully closed, for example. The electronic control device 30 receives a signal indicating an intake pressure PM from an intake pressure sensor 36. The intake pressure sensor 36 detects the intake pressure PM in the intake channel of the engine 10 at a position downstream of the throttle valve.

The electronic control device 30 receives a signal indicating a rotational position CA of the crankshaft 10b from a crank angle sensor 37. The crank angle sensor 37 detects the rotational position CA of the crankshaft 10b of the engine 10 every unit time. The electronic control device 30 receives a signal indicating a cooling water temperature THW in the engine 10 from a cooling water temperature sensor 38. The cooling water temperature sensor 38 is attached to the outlet of the water jacket formed in the cylinder block or the cylinder head of the engine 10, and detects the temperature of cooling water at the outlet of the water jacket as the cooling water temperature THW.

Based on the various input signals, the electronic control device 30 generates an operation signal MSmg for controlling the motor generator 20 and outputs the operation signal MSmg to the motor generator 20. More specifically, in order to make the motor generator 20 apply a positive rotational torque to the crankshaft 10b of the engine 10, the electronic control device 30 generates and outputs an operation signal MSmg that causes the motor generator 20 to operate as an electric motor on the electric power from the high-voltage battery 22. In order to make the motor generator 20 apply a negative rotational torque to the crankshaft 10b of the engine 10, the electronic control device 30 generates and outputs an operation signal MSmg that causes the motor generator 20 to operate as a generator and supply electric power to the high-voltage battery 22 and the DC/DC converter 23.

If a request to start the engine 10 occurs when the engine 10 is in a stopped state, the electronic control device 30 performs a control to make the starter 25A apply a positive rotational torque to the crankshaft 10b of the engine 10 to start the engine 10. The request to start the engine 10 referred to herein is a start request issued in response to a driver of the vehicle turning on the ignition switch (which is referred to also as an engine start switch or a system activation switch, for example). If a request to restart the engine 10 occurs when the engine 10 is in the stopped state, the electronic control device 30 performs a control to make the motor generator 20 apply a positive rotational torque to the crankshaft 10b of the engine 10 to start the engine 10. The request to restart the engine 10 referred to herein is a request to automatically restart the engine 10 after the engine 10 is temporarily stopped (for idle reduction) at a traffic light.

Next, a relationship between the rotational position (stop position) of the crankshaft 10b of the engine 10 when the engine 10 is stopped and the torque required to start the engine 10 in the stopped state will be described.

As shown in FIG. 2, since the engine 10 according to this embodiment has four cylinders 10a, when the engine 10 is stopped, one of the four cylinders 10a is in the expansion stroke, and one of the other three cylinders 10a is in the compression stroke. Suppose that the first cylinder 10a is in the expansion stroke when the engine 10 is stopped.

The earlier the rotational position of the crankshaft 10b when the engine 10 is stopped lies in the expansion stroke of the first cylinder 10a, the smaller the amount of air in the first cylinder 10a is when the engine 10 is started. Therefore, in order for the crankshaft 10b to get over the bottom dead center (BDC) of the expansion stroke of the first cylinder 10a to rotate, the crankshaft 10b needs to rotate against the negative pressure in the first cylinder 10a and requires a high torque.

If the first cylinder 10a is in the expansion stroke when the engine 10 is stopped, the third cylinder 10a is in the compression stroke. The earlier the rotational position of the crankshaft 10b when the engine 10 is stopped lies in the compression stroke of the third cylinder 10a, the larger the amount of air in the third cylinder 10a is when the engine 10 is started. Therefore, in order for the crankshaft 10b to get over the top dead center (TDC) of the compression stroke of the third cylinder 10a to rotate, the crankshaft 10b needs to rotate against the pressure of the gas in the third cylinder 10a and requires a high torque.

That is, the earlier the rotational position of the crankshaft 10b when the engine 10 is stopped lies in the expansion stroke of the first cylinder 10a in the expansion stroke, the higher the required starting torque becomes, and the later the rotational position of the crankshaft 10b when the engine 10 is stopped lies in the expansion stroke, the lower the required starting torque becomes.

However, for a certain period after the compression stroke of the third cylinder 10a starts, the intake valve of the third cylinder 10a in the compression stroke is not closed but open. In the period in which the intake valve is open, some air can be discharged through the intake port even in the compression stroke. Therefore, the required starting torque is somewhat lower in the certain period after the compression stroke of the third cylinder 10a starts, and is at the maximum when the crankshaft 10b reaches a rotational position at which the intake valve of the third cylinder 10a is closed.

For a certain last period in the expansion stroke, the exhaust valve of the first cylinder 10a in the expansion stroke is open. In the period in which the exhaust valve is open, some air can be taken in through the exhaust valve even in the expansion stroke. Therefore, the required starting torque is lower in the certain period before the expansion stroke of the first cylinder 10a ends. However, if the rotational position of the crankshaft 10b at the time when the crankshaft 10b starts rotating is too close to the rotational position at which the bottom dead center of the expansion stroke of the first cylinder 10a or the top dead center of the compression stroke of the third cylinder 10a is reached, the inertia of the crankshaft 10b or the inertia of the piston that reciprocates in each cylinder 10a is difficult to take advantage of to get over the bottom dead center or the top dead center. Therefore, concerning the third cylinder 10a that is in the compression stroke when the engine 10 is in the stopped state, the closer to the time when the expansion stroke of the first cylinder 10a ends is in a period immediately before the expansion stroke of the first cylinder 10a ends the crankshaft 10b stops, the higher the required starting torque becomes.

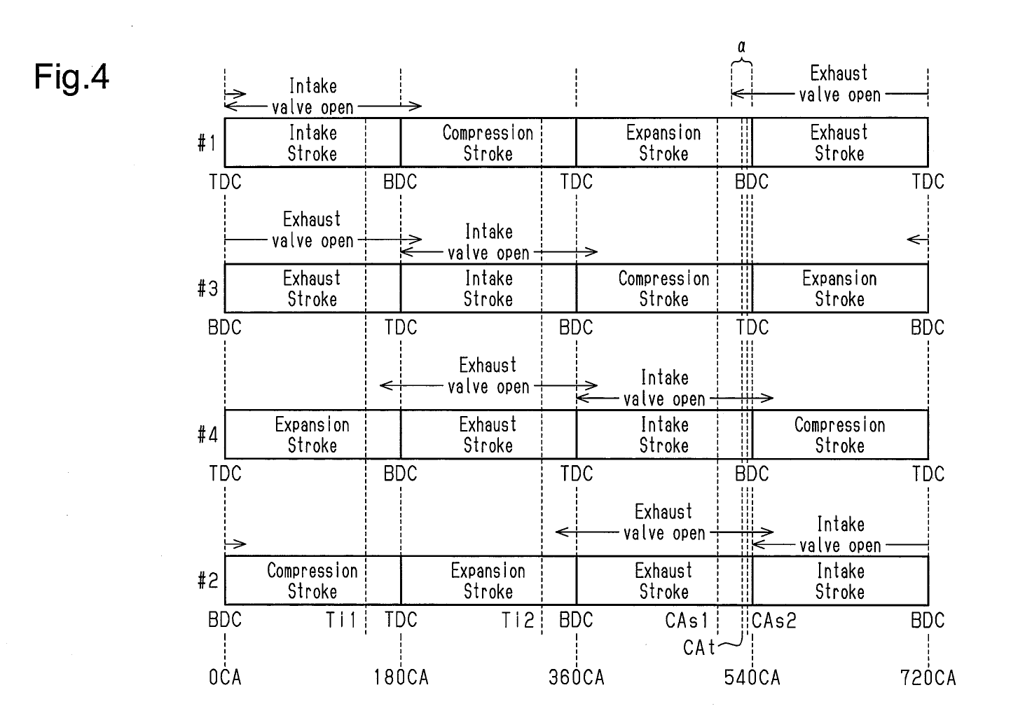

Furthermore, as shown in FIG. 4, when the first cylinder 10a is in the expansion stroke, the fourth cylinder 10a is in the intake stroke, and the second cylinder 10a is in the exhaust stroke. Air can flow in and out of the fourth cylinder 10a in the intake stroke, since the intake valve is open throughout the intake stroke. Air can also flow in and out of the second cylinder 10a in the exhaust stroke, since the exhaust valve is open throughout the exhaust stroke. However, the fourth cylinder 10a, which is in the intake stroke when the engine 10 is in the stopped state, enters the compression stroke following the third cylinder 10a immediately after the engine 10 is started. In order to get over the top dead center of the compression stroke of the fourth cylinder 10a, an appropriate rotational angle is preferably ensured between the rotational position of the crankshaft 10b at the time when the engine 10 is in the stopped state and the rotational position of the crankshaft 10b where the top dead center of the compression stroke of the fourth cylinder 10a is reached. That is, if the rotational position of the crankshaft 10b is too close to the rotational position at which the bottom dead center of the expansion stroke of the first cylinder 10a is reached or the rotational position at which the top dead center of the compression stroke of the third cylinder 10a is reached, the inertia of the pistons or the like is difficult to take advantage of, so that it is difficult for the piston in the fourth cylinder 10a, which enters the compression stroke following the third cylinder 10a, to get over the top dead center. Therefore, concerning the fourth cylinder 10a that is in the intake stroke when the engine 10 is in the stopped state, the closer to the time when the expansion stroke of the first cylinder 10a ends is in a period immediately before the expansion stroke of the first cylinder 10a ends the crankshaft 10b stops, the higher the required starting torque becomes.

With such characteristics, as shown in FIG. 2, when the first cylinder 10a is in the expansion stroke, the required starting torque for starting the engine 10 is at the minimum at a rotational position close to the rotational position at which the exhaust valve of the first cylinder 10a is opened. Although a case where the first cylinder 10a is in the expansion stroke has been described as an example, the same holds true for a case where another cylinder 10a is in the expansion stroke.

Next, an engine stop controlling process for the engine 10 performed by the electronic control device 30 will be described. The engine stop controlling process is performed in response to a request to stop or temporarily stop the engine 10. The request to stop the engine 10 referred to herein is a stop request issued in response to the driver of the vehicle turning off the ignition switch. The request to temporarily stop the engine 10 referred to herein is a temporary stop request issued to temporarily stop the engine 10 (or stop idling). In this embodiment, it is assumed that when the engine 10 is stopped, the timing at which the exhaust valve is opened is earlier than the timing at which the expansion stroke of the cylinder 10a ends (or the exhaust stroke starts).

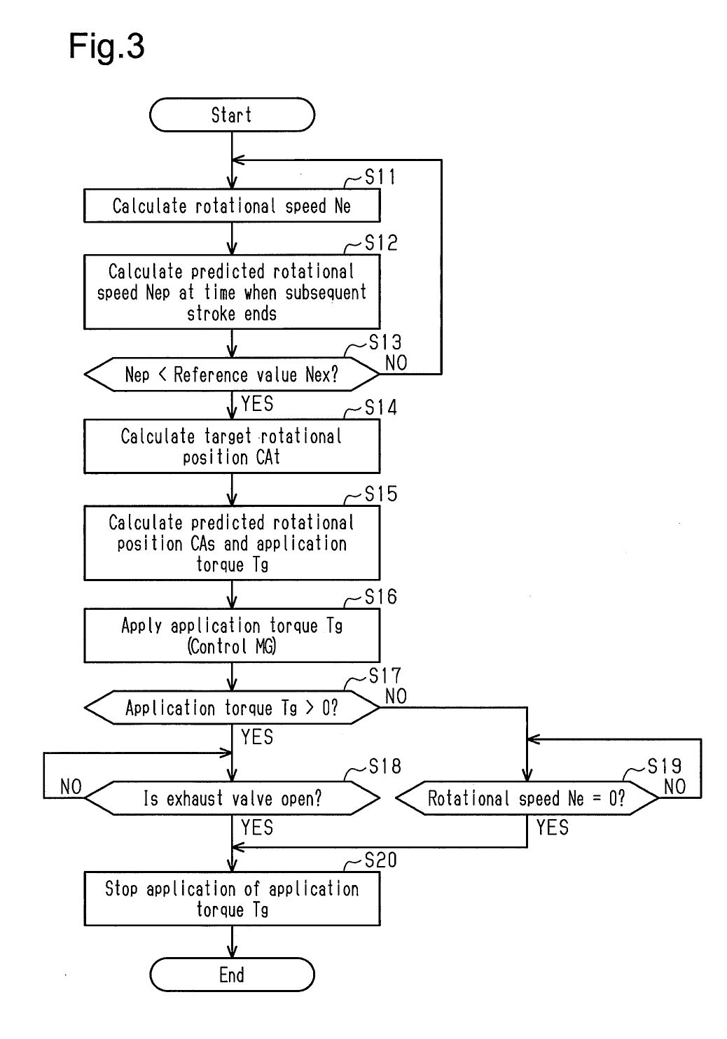

As shown in FIG. 3, when started by the electronic control device 30, the engine stop controlling process for the engine 10 proceeds to Step S11. In Step S11, the electronic control device 30 calculates a rotational speed Ne of the engine 10 (rotational speed of the crankshaft 10b) at the time of Step S11. More specifically, the electronic control device 30 calculates the rotational speed Ne based on the difference between the latest rotational position CA detected by the crank angle sensor 37 and the rotational position CA detected a unit time earlier than the latest rotational position. Once the rotational speed Ne is calculated, the process performed by the electronic control device 30 proceeds to Step S12.

In Step S12, the electronic control device 30 identifies in which stroke each cylinder 10a is at the time of Step S12, and calculates a predicted value of the rotational speed Ne of the engine 10 at the end of the subsequent stroke as a predicted rotational speed Nep. More specifically, for example, in FIG. 4, if the rotational position of the crankshaft 10b lies between 0 and 180 CA (that is, if the first cylinder 10a is in the intake stroke), the electronic control device 30 calculates the predicted rotational speed Nep at the time when the rotational position of the crankshaft 10b is 360 CA (that is, when the compression top dead center is reached in the first cylinder 10a). The predicted rotational speed Nep is calculated based on the throttle opening TA detected by the throttle sensor 35, the intake pressure PM detected by the intake pressure sensor 36, the rotational position CA (rotational speed Ne) detected by the crank angle sensor 37, and the cooling water temperature THW detected by the cooling water temperature sensor 38, for example. The computational expression or the like for calculating the predicted rotational speed Nep can be a known computational expression or the like, such as the computational expression disclosed in Japanese Laid-Open Patent Publication No. 2016-200007 described above. After that, as shown in FIG. 3, the process performed by the electronic control device 30 proceeds to Step S13.

In Step S13, the electronic control device 30 determines whether or not the predicted rotational speed Nep calculated in Step S12 is smaller than a predetermined reference value Nex. In this embodiment, the reference value Nex is 0. If it is determined that the predicted rotational speed Nep is equal to or greater than the reference value Nex (if NO in Step S13), the electronic control device 30 assumes that the crankshaft 10b will not start rotating in the reverse direction in the subsequent stroke of each cylinder 10a. Then, the process performed by the electronic control device 30 returns to Step S11.

In contrast, if it is determined that the predicted rotational speed Nep is smaller than the reference value Nex (if YES in Step S13), the electronic control device 30 assumes that the crankshaft 10b will start rotating in the reverse direction in the subsequent stroke of each cylinder 10a. Then, the process performed by the electronic control device 30 proceeds to Step S14.

In Step S14, the electronic control device 30 calculates a target rotational position CAt of the crankshaft 10b. In this embodiment, the target rotational position CAt is a midpoint between the rotational position CA of the crankshaft 10b at the time when the exhaust valve of the cylinder 10a that is in the expansion stroke when the crankshaft 10b starts rotating in the revere direction is opened and the rotational position CA of the crankshaft 10b at the time when the bottom dead center is reached in the expansion stroke of the cylinder 10a that is in the expansion stroke when the crankshaft 10b starts rotating in the reverse direction. More specifically, for example, in FIG. 4, if the cylinder 10a that is in the expansion stroke when the crankshaft 10b starts rotating in the reverse direction is the first cylinder 10a, the target rotational position CAt is (540−(a/2)) CA, which is the midpoint between (540−a) CA, which is the rotational position at which the exhaust valve is opened, and 540 CA, which is the rotational position at which the bottom dead center is reached in the expansion stroke. As described above, the rotational position CA at which the required starting torque is at the minimum lies in the vicinity of the rotational position CA at which the exhaust valve of the cylinder 10a that is in the expansion stroke when the crankshaft 10b starts rotating in the reverse direction is opened. Therefore, the target rotational position CAt is set slightly beyond the rotational position CA at which the required starting torque is at the minimum. Once the target rotational position CAt is calculated, the process performed by the electronic control device 30 proceeds to Step S15, as shown in FIG. 3.

In Step S15, the electronic control device 30 calculates, as a predicted rotational position CAs, the rotational position CA of the crankshaft 10b at the time when the crankshaft 10b starts rotating in the reverse direction based on the rotational speed Ne of the engine 10 calculated in Step S11. More specifically, the predicted rotational position CAs is calculated so that the higher the rotational speed Ne of the engine 10, the longer becomes the distance between the rotational position CA and the predicted rotational position CAs of the crankshaft 10b at the time of Step S15. That is, the electronic control device 30 serves as a rotational position prediction section that predicts the rotational position CA of the crankshaft 10b at the time when the crankshaft 10b starts rotating in the reverse direction as the predicted rotational position CAs.

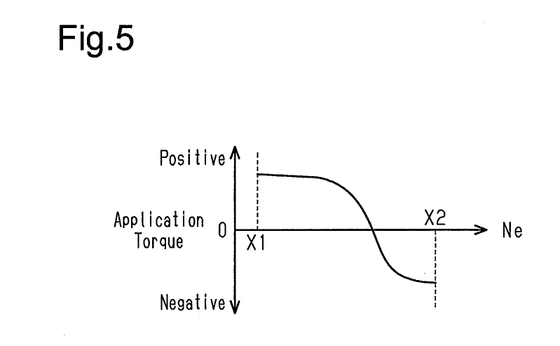

In Step S15, the electronic control device 30 calculates an application torque Tg (the amount of output power or power generation of the motor generator 20), which is a torque to be applied to the crankshaft 10b of the engine 10 per unit time. The calculated application torque Tg is 0 when the predicted rotational position CAs and the target rotational position CAt agree with each other. The calculated application torque Tg is a positive rotational torque when the predicted rotational position CAs is behind the target rotational position CAt. The calculated application torque Tg is a negative rotational torque when the predicted rotational position CAs is beyond the target rotational position CAt. The lower the rotational speed Ne of the engine 10, the larger becomes the extent to which the predicted rotational position CAs calculated as a rotational position CA is behind the target rotational position CAt, and the higher the rotational speed Ne of the engine 10, the larger becomes the extent to which the predicted rotational position CAs calculated as a rotational position CA is beyond the target rotational position CAt. Therefore, as shown in FIG. 5, the application torque Tg calculated as a positive rotational torque increases as the rotational speed Ne decreases, and the application torque Tg calculated as a negative rotational torque increases in absolute value as the rotational speed Ne increases.

As shown in FIG. 5, when the rotational speed Ne of the engine 10 is lower than a certain rotational speed X1, it is considered that the crankshaft 10b starts rotating in the reverse direction in the stroke immediately preceding the stroke of the cylinder 10a in which the predicted rotational position CAs is supposed to be in Step S15. When the rotational speed Ne of the engine 10 is higher than a certain rotational speed X2 that is higher than the rotational speed X1, it is considered that the crankshaft 10b starts rotating in the reverse direction in the stroke immediately following the stroke of the cylinder 10a in which the predicted rotational position CAs is supposed to be in Step S15 (that is, NO in Step S13 is determined. Therefore, the relationship between the application torque Tg and the rotational speed Ne of the engine 10 (predicted rotational position CAs) has only to be determined in advance within the range from the rotational speed X1 and the rotational speed X2. Following Step S15, the process performed by the electronic control device 30 proceeds to Step S16.

In Step S16, the electronic control device 30 applies the application torque Tg calculated in Step S15 to the crankshaft 10b of the engine 10. More specifically, the electronic control device 30 generates an operation signal MSmg according to the application torque Tg, and outputs the operation signal MSmg to the motor generator 20. That is, the electronic control device 30 serves as an application torque control section that controls the positive rotational torque and the negative rotational torque applied by the motor generator 20 to the crankshaft 10b of the engine 10. Following Step S16, the process performed by the electronic control device 30 proceeds to Step S17.

In Step S17, the electronic control device 30 determines whether or not the application torque Tg calculated in Step S15 is greater than 0. If it is determined that the application torque Tg is greater than 0 (if YES in Step S17), the process performed by the electronic control device 30 proceeds to Step S18.

In Step S18, the electronic control device 30 identifies the cylinder 10a that is in the expansion stroke when the rotational position CA of the crankshaft 10b is the predicted rotational position CAs, and determines whether or not the exhaust valve of the identified cylinder 10a is opened. If it is determined that the exhaust valve of the cylinder 10a that is in the expansion stroke is not opened but still closed (if NO in Step S18), the process performed by the electronic control device 30 proceeds to Step S18 again. That is, the electronic control device 30 repeats Step S18 until the exhaust valve of the cylinder 10a that is in the expansion stroke is opened. If it is determined that the exhaust valve of the cylinder 10a that is in the expansion stroke is opened (if YES in Step S18), the process performed by the electronic control device 30 proceeds to Step S20.

In Step S20, the electronic control device 30 stops applying the application torque Tg to the crankshaft 10b of the engine 10. That is, the electronic control device 30 generates an operation signal MSmg to stop the motor generator 20, and outputs the operation signal MSmg to the motor generator 20. Then, the engine stop controlling process for the engine 10 performed by the electronic control device 30 ends.

In contrast, if it is determined in Step S17 that the application torque Tg is equal to or less than 0 (if NO in Step S17), the process performed by the electronic control device 30 proceeds to Step S19. In Step S19, the electronic control device 30 determines whether or not the rotational speed Ne of the engine 10 has become 0, that is, whether or not the crankshaft 10b has started rotating in the reverse direction. If it is determined that the rotational speed Ne of the engine 10 has not become 0 (if NO in Step S19), the process performed by the electronic control device 30 proceeds to Step S19 again. That is, the electronic control device 30 repeats Step S19 until the rotational speed Ne of the engine 10 becomes 0. If it is determined that the rotational speed Ne of the engine 10 has become 0 (if YES in Step S19), the process performed by the electronic control device 30 proceeds to Step S20. In Step S20, the electronic control device 30 stops applying the application torque Tg to the crankshaft 10b of the engine 10, and then, the engine stop controlling process for the engine 10 performed by the electronic control device 30 ends.

Next, an operation and advantages of the embodiment described above will be described. In the following description, as shown in FIG. 4, it is assumed that the intake stroke of the first cylinder 10a starts at 0 CA, and the exhaust stroke ends at 720 CA. In addition, it is assumed that the first cylinder 10a is in the expansion stroke when the crankshaft 10b starts rotating in the reverse direction.

For example, as shown in FIG. 4, it is supposed that the engine stop controlling process for the engine 10 is started when the first cylinder 10a is in the intake stroke, that is, at a time Ti1 when the rotational position CA of the crankshaft 10b lies between 0 and 180 CA. If the electronic control device 30 performs Step S13 when the first cylinder 10a is in the intake stroke, the electronic control device 30 determines whether or not the predicted rotational speed Nep is lower than the reference value Nex (Nex=0) at the time when the compression stroke of the first cylinder 10a ends, that is, when the rotational position CA of the crankshaft 10b is 360 CA. In the example described here, the first cylinder 10a is in the expansion stroke when the crankshaft 10b starts rotating in the reverse direction as described above. Therefore, the predicted rotational speed Nep at the time when the compression stroke of the first cylinder 10a ends must be predicted to be a positive value, so that it is determined that the predicted rotational speed Nep is equal to or higher than the reference value Nex (Nex=0). Therefore, while the first cylinder 10a is in the intake stroke, the process performed by the electronic control device 30 does not proceed to Step S14 and the following steps.

After that, as shown in FIG. 4, for example, it is supposed that the electronic control device 30 performs Step S13 when the first cylinder 10a is in the compression stroke, that is, at a time Ti2 when the rotational position CA of the crankshaft 10b lies between 180 CA and 360 CA. In this case, the electronic control device 30 determines whether or not the predicted rotational speed Nep is lower than the reference value Nex (Nex=0) at the time when the expansion stroke of the first cylinder 10a ends (when the rotational position CA of the crankshaft 10b is 540 CA). In the example described here, the first cylinder 10a is in the expansion stroke when the crankshaft 10b starts rotating in the reverse direction as described above. Therefore, it is considered that the crankshaft 10b starts rotating in the reverse direction before the expansion stroke of the first cylinder 10a ends, and then stops rotating, so that the predicted rotational speed Nep is predicted to be a negative value. Therefore, the electronic control device 30 determines that the predicted rotational speed Nep is lower than the reference value Nex (Nex=0), and performs Step S14 and the following steps.

Here, it is supposed that a predicted rotational position CAs1 of the crankshaft 10b at the time when the crankshaft 10b starts rotating in the reverse direction is behind the target rotational position CAt. Note that the predicted rotational position CAs including the predicted rotational position CAs1 as an example lies between 360 CA and (540−a/2) CA. When the predicted rotational position CAs1 is behind the target rotational position CAt as in this case, the motor generator 20 applies a positive application torque Tg to the crankshaft 10b. Therefore, the crankshaft 10b does not stop at the predicted rotational position CAs1 but continue rotating.

After that, in FIG. 5, when (540−a) CA, the rotational position CA at which the exhaust valve of the first cylinder 10a is opened, is reached, the application of the positive application torque Tg to the crankshaft 10b is stopped. Therefore, the crankshaft 10b tends to stop rotating. However, even after the application of the positive application torque Tg to the crankshaft 10b is stopped, the crankshaft 10b slightly rotates by inertia of the crankshaft 10b, the pistons and the like. In contrast, when the crankshaft 10b starts rotating in the reverse direction, a reaction force of compressed air occurs in the third cylinder 10a that is in the compression stroke. Therefore, it is considered that the crankshaft 10b is unlikely to get over the top dead center of the compression stroke of the third cylinder 10a to rotate. Instead, it is considered that the crankshaft 10b rotates in the reverse direction under the reaction force produced by the air in the third cylinder 10a and stops at a rotational position CA that is slightly behind the target rotational position CAt, that is, in the vicinity of the rotational position CA at which the exhaust valve is opened. As described above, the required starting torque is at the minimum in the vicinity of the rotational position CA at which the exhaust valve of the first cylinder 10a is opened. Therefore, the crankshaft 10b will stop rotating at the rotational position CA at which the required starting torque for the engine 10 is low.

Next, it is supposed that a predicted rotational position CAs2 of the crankshaft 10b at the time when the crankshaft 10b starts rotating in the reverse direction is beyond the target rotational position CAt. Note that the predicted rotational position CAs2 lies between (540−a/2) CA and 540 CA. In this case, the motor generator 20 applies a negative application torque Tg to the crankshaft 10b. Therefore, the crankshaft 10b tends to stop before reaching the predicted rotational position CAs2.

After that, when the rotational speed Ne of the engine 10 becomes 0, that is, when the crankshaft 10b stops rotating, the application of the negative application torque Tg to the crankshaft 10b is stopped, and the crankshaft 10b tends to stop rotating. However, even after the application of the negative application torque Tg to the crankshaft 10b is stopped, in the third cylinder 10a that is in the compression stroke when the crankshaft 10b starts rotating in the reverse direction, the compressed air in the third cylinder 10a produces a reaction force. Therefore, even after the application of the negative application torque Tg is stopped, the crankshaft 10b slightly rotates because of the reaction force produced in the third cylinder 10a that is in the compression stroke when the crankshaft 10b starts rotating in the reverse direction. Once the crankshaft 10b starts rotating in the reverse direction, the reaction force produced in the third cylinder 10a decreases, so that it is considered that the crankshaft 10b is unlikely to rotate in the reverse direction to a large extent. That is, it is considered that the crankshaft 10b is unlikely to rotate in the reverse direction beyond the target rotation position CAt to a large extent. Thus, the crankshaft 10b stops rotating in the vicinity of the rotational position CA at which the exhaust valve is opened, which is slightly behind the target rotational position CAt.

In the engine stop controlling process for the engine 10 described above, the timing of applying the application torque Tg to the crankshaft 10b is determined based on the actual rotational position CA of the crankshaft 10b detected by the crank angle sensor 37. Therefore, even if the behavior of the rotation of the crankshaft 10b slightly varies as the engine 10 varies with time, the stop position of the crankshaft 10b is prevented from being largely shifted from the rotational position at which the required starting torque is at the minimum.

In the embodiment described above, the motor generator 20 is employed as a device that applies the application torque Tg to the crankshaft 10b. Since the motor generator 20 is a three-phase alternating-current motor as described above, the application torque Tg applied to the crankshaft 10b can be relatively accurately controlled. Therefore, the application torque Tg applied to the crankshaft 10b does not largely increase or decrease.

In the embodiment described above, to start the engine 10 after the engine 10 is temporarily stopped, the motor generator 20 is used. When the motor generator 20 is used to start the engine 10, if the rotational speed Ne of the engine 10 is close to 0, the rotational torque that can be applied to the engine 10 by the motor generator 20 is smaller than the rotational torque that can be applied by the starter 25A. On this assumption, the engine stop controlling process for the engine 10 according to this embodiment, in which the stop position of the crankshaft 10b at the time when the engine 10 is stopped is caused to agree with the rotational position at which the required starting torque is at the minimum, is highly preferable in order to ensure that the motor generator 20 starts the engine 10 with higher reliability.

In the embodiment described above, the larger the extent to which the predicted rotational position CAs is behind the target rotational position CAt, the greater positive rotational torque the calculated application torque Tg becomes. In other words, the smaller the extent to which the predicted rotational position CAs is behind the target rotational position CAt, the smaller positive rotational torque the calculated application torque Tg becomes. Therefore, the time from when the crankshaft 10b gets over the predicted rotational position CAs to when the application of the application torque Tg is stopped is prevented from being excessively long. Furthermore, the larger the extent to which the predicted rotational position CAs is beyond the target rotational position CAt, the greater absolute value the application torque Tg calculated as a negative rotational torque has. Therefore, the time from when the crankshaft 10b gets over the target rotational position CAt to when the crankshaft 10b starts rotating in the reverse direction is prevented from being excessively long.

The above-described embodiment may be modified as follows. The present embodiment and the following modifications can be combined as long as the combined modifications remain technically consistent with each other.

The way of drivably coupling the engine 10 and the motor generator 20 to each other is not limited to that according to the embodiment described above. For example, a speed reduction mechanism formed by a plurality of gears or the like, or a clutch that engages and disengages the driving power transmission may be arranged between the engine 10 and the motor generator 20. That is, the embodiment described above can be implemented in any way of drivably coupling as far as the motor generator 20 can apply a positive or negative application torque Tg to the crankshaft 10b of the engine 10.

The high-voltage battery 22 and the low-voltage battery 24 can have any output voltage. The high-voltage battery 22 may be a battery that has an output voltage lower than 48 V or a battery that has an output voltage higher than 48 V. The low-voltage battery 24 does not necessarily have to have a lower output voltage than the high-voltage battery 22, and the low-voltage battery 24 and the high-voltage battery 22 may have the same output voltage.

The types of the high-voltage battery 22 and the low-voltage battery 24 are not limited to the examples in the embodiment described above. For example, as the high-voltage battery 22 and the low-voltage battery 24, a nickel metal hydride battery or a NAS battery may be used instead of the lithium ion battery and the lead-acid battery.

A motor generator that primarily assists the engine 10 to provide a running torque and a motor generator that is driven by the torque from the engine 10 to generate electricity may be separately provided. In this case, the motor generator that assists the engine 10 to provide a running torque serves as the torque applying device that applies a positive rotational torque, and the motor generator that generates electricity serves as the torque applying device that applies a negative torque.

The torque applying device that applies a positive rotational torque is not limited to the motor generator 20. For example, the starter 25A also serves as the torque applying device that applies a positive rotational torque, because the starter 25A can apply the application torque Tg to the crankshaft 10b of the engine 10 when the engine 10 is stopped. In this modification, both the starter 25A and the motor generator 20 may be used as the torque applying device that applies a positive rotational torque.

The torque applying device that applies a negative rotational torque is not limited to the motor generator 20. For example, if a friction brake or the like is provided to reduce the speed of the rotation of the crankshaft 10b, the friction brake may serve as the torque applying device that applies a negative rotational torque. Alternatively, if a lock-up clutch is arranged between the crankshaft 10b of the engine 10 and the drive wheels, the lock-up clutch may apply a negative rotational torque to the crankshaft 10b by temporarily linking the crankshaft 10b and the drive wheels to each other when the engine is stopped. This is because, when the engine is stopped, the drive wheels of the vehicle are stopped or almost stopped, so that when the crankshaft 10b is connected to the drive wheels, the drive wheels provide a resistance to rotation of the crankshaft 10b. In this case, the lock-up clutch may serve as the torque applying device that applies a negative rotational torque. In these modifications, both the friction brake or lock-up clutch and the motor generator 20 may be used as the torque applying device that applies a negative rotational torque.

If a mechanism other than the motor generator 20 is used as the torque applying device as in the modifications described above, the motor generator 20 and associated components may be omitted. In that case, the engine stop controlling process for the engine 10 described above is preferable in that the required starting torque for starting the engine 10 with the starter 25A, for example, is minimized.

In the embodiment described above, the processing of applying the application torque Tg that is performed if the predicted rotational position CAs is beyond the target rotational position CAt may be omitted. In other words, only the processing of applying a positive application torque Tg may be performed, and the processing involved with application of a negative application torque Tg may be omitted.

Alternatively, the processing of applying the application torque Tg that is performed if the predicted rotational position CAs is behind the target rotational position CAt may be omitted. In other words, only the processing of applying a negative application torque Tg may be performed, and the processing involved with application of a positive application torque Tg may be omitted.

The reference value Nex in the embodiment described above may not be 0. For example, as shown in FIG. 4, it is supposed that the process described above is performed when the first cylinder 10a is in the compression stroke, and the predicted rotational speed Nep at the time when the expansion stroke of the first cylinder 10a ends is calculated to be a positive value. When the predicted rotational speed Nep is calculated to be a positive value, it is ideal that the crankshaft 10b gets over the bottom dead center of the expansion stroke of the first cylinder 10a to rotate. However, if the engine 10 varies with time, the computational expression or the like for calculating the predicted rotational speed Nep may deviate from the actual behavior of the engine 10. In that case, even though the predicted rotational speed Nep is calculated to be a positive value, the crankshaft 10b may start rotating in the reverse direction while the first cylinder 10a is in the expansion stroke. In view of this, for example, if the reference value Nex is set at a positive value, in the above example, even when it is uncertain whether the crankshaft 10b rotates beyond the expansion stroke, it can be assumed that the crankshaft 10b starts rotating in the reverse direction when the first cylinder 10a is in the expansion stroke. In this modification, a corresponding negative application torque Tg is applied to the crankshaft 10b. Thus, the crankshaft 10b is unlikely to get over the bottom dead center of the expansion stroke despite the assumption that the crankshaft 10b starts rotating in the reverse direction while the first cylinder 10a is in the expansion stroke.

In the embodiment described above, the predicted rotational position CAs does not necessarily have to be calculated as the rotational position CA of the crankshaft 10b. Any parameter that can reflect the rotational position CA of the crankshaft 10b at the time when the crankshaft 10b starts rotating in the reverse direction can be used. For example, the predicted rotational position CAs may be calculated as the rotational speed Ne of the engine 10 at the time when the crankshaft 10b reaches the target rotational position CAt. In that case, if the rotational speed Ne as the predicted rotational position CAs is 0, the crankshaft 10b will start rotating in the reverse direction at the target rotational position CAt. If the rotational speed Ne as the predicted rotational position CAs is negative, the crankshaft 10b will start rotating in the reverse direction at a position behind the target rotational position CAt. If the rotational speed Ne as the predicted rotational position CAs is positive, the crankshaft 10b will start rotating in the reverse direction at a position beyond the target rotational position CAt.

In the embodiment described above, the positive application torque Tg applied when the predicted rotational position CAs is behind the target rotational position CAt may be a fixed value. Even if the positive application torque Tg is a fixed value, application of the application torque Tg is stopped when the exhaust valve of the cylinder 10a that is in the expansion stroke when the crankshaft 10b starts rotating in the reverse direction is opened, so that the crankshaft 10b of the engine 10 stops in the close vicinity of the rotational position at which the required starting torque is at the minimum. Similarly, the negative application torque Tg applied when the predicted rotational position CAs is beyond the target rotational position CAt may be a fixed value. Even if the negative application torque Tg is a fixed value, application of the application torque Tg is stopped when the rotational speed Ne of the engine 10 becomes 0, so that the crankshaft 10b of the engine 10 stops in the close vicinity of the rotational position at which the required starting torque is at the minimum.

As in the modification described above, if the positive application torque Tg or the negative application torque Tg is a fixed value, the predicted rotational position CAs is accurate enough if it can be determined whether the predicted rotational position CAs agrees with the target rotational position CAt, is behind the target rotational position CAt or is beyond the target rotational position CAt. That is, the predicted rotational position CAs does not have to be calculated as a specific rotational position CA and has only to allow calculation of the corresponding application torque Tg.

The target rotational position CAt is not limited to the midpoint between the rotational position CA at which the exhaust valve of the cylinder 10a that is in the expansion stroke when the crankshaft 10b starts rotating in the reverse direction is opened and the rotational position CA at which the expansion stroke of the same cylinder 10a ends. The target rotational position CAt has only to be set within the range between the rotational position CA at which the exhaust valve of the cylinder 10a is opened and the rotational position CA at which the expansion stroke of the cylinder 10a ends. Furthermore, if the rotational position CA at which the required starting torque is at the minimum can be uniquely calculated, the target rotational position CAt may be a rotational position beyond the calculated rotational position CA. As described above, the crankshaft 10b starts rotating in the reverse direction in the vicinity of the target rotational position CAt and finally stops rotating at a rotational position behind the target rotational position CAt. Therefore, if the target rotational position CAt is set beyond the rotational position CA at which the required starting torque is at the minimum, the crankshaft 10b finally stops rotating in the vicinity of the rotational position CA at which the required starting torque is at the minimum.

The target rotational position CAt may also be a fixed value. If the variable valve timing mechanism is employed in the engine 10, the timing of opening the exhaust valve can vary. For example, if a fixed target rotational position CAt is set beyond the rotational position that corresponds to the latest possible timing of opening the exhaust valve when the engine 10 is stopped, no problem arises even if the timing of opening the exhaust valve varies.

In the embodiment described above, the engine stop controlling process for the engine 10 is performed both when a request to stop the engine 10 is received and when a request to temporarily stop the engine 10 is received. However, the engine stop controlling process may be applied only one of when a request to stop the engine 10 is received and when a request to temporarily stop the engine 10 is received.

In the embodiment described above, the engine 10 is started by the motor generator 20 when a request to restart the engine 10 is received. In addition, or alternatively, the engine 10 may be started by the motor generator 20 when a request to start the engine 10 is received. However, when the engine 10 is stopped immediately before the engine 10 is started by the motor generator 20, the engine stop controlling process for the engine 10 according to the embodiment described above is preferably performed.

The control device is not limited to a device that includes a CPU, a ROM, and a RAM and executes software processing. For example, a dedicated hardware circuit (such as an ASIC) may be provided that executes at least part of the software processes executed in each of the above-described embodiments. That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

1. A driving system for a vehicle, comprising:
an engine having four cylinders;
a torque applying device configured to be capable of applying a positive rotational torque to a crankshaft of the engine;
a crank angle sensor configured to detect a rotational position of the crankshaft; and
an engine stop controlling device configured to control the rotational position of the crankshaft when the engine is stopped, wherein
the engine stop controlling device includes
a rotational position prediction section configured to predict a predicted rotational position based on the rotational position detected by the crank angle sensor when the engine is stopped, the predicted rotational position being a rotational position of the crankshaft at a time when the crankshaft starts rotating in a reverse direction, and
an application torque control section configured to control the torque applying device to apply a positive rotational torque to the crankshaft when the predicted rotational position is behind a target rotational position, the target rotational position being set within a range of the rotational position of the crankshaft between a time when an exhaust valve of one of the four cylinders that is in an expansion stroke when the crankshaft starts rotating in the reverse direction is opened and a time when the expansion stroke of the cylinder ends, and
the application torque control section is configured to stop application of the positive rotational torque from the torque applying device to the crankshaft at the time when the exhaust valve of the cylinder that is in the expansion stroke when the crankshaft starts rotating in the reverse direction is opened.

2. A driving system for a vehicle, comprising:
an engine having four cylinders;
a torque applying device configured to be capable of applying a negative rotational torque to a crankshaft of the engine;
a crank angle sensor configured to detect a rotational position of the crankshaft; and
an engine stop controlling device configured to control the rotational position of the crankshaft when the engine is stopped, wherein
the engine stop controlling device includes
a rotational position prediction section configured to predict a predicted rotational position based on the rotational position detected by the crank angle sensor when the engine is stopped, the predicted rotational position being a rotational position of the crankshaft at a time when the crankshaft starts rotating in a reverse direction, and
an application torque control section configured to control the torque applying device to apply a negative rotational torque to the crankshaft when the predicted rotational position is beyond a target rotational position, the target rotational position being set within a range of the rotational position of the crankshaft between a time when an exhaust valve of one of the four cylinders that is in an expansion stroke when the crankshaft starts rotating in the reverse direction is opened and a time when the expansion stroke of the cylinder ends, and
the application torque control section is configured to stop application of the negative rotational torque from the torque applying device to the crankshaft when the crankshaft starts rotating in the reverse direction.

3. The driving system for a vehicle according to claim 1, wherein
the torque applying device includes a motor generator that is drivably coupled to the engine,
the motor generator is configured to be driven by a rotational torque from the engine and generate electricity and to be supplied with electric power form a battery and apply a rotational torque to the engine, and
the torque applying device is configured to control the motor generator to apply a positive rotational torque to the engine when the engine in a stopped state is started.

4. A driving method for a vehicle, comprising:
detecting, by a crank angle sensor, a rotational position of a crankshaft of an engine having four cylinders;
predicting a predicted rotational position based on the rotational position detected by the crank angle sensor when the engine is stopped, thereby controlling the rotational position of the crankshaft when the engine is stopped, the predicted rotational position being a rotational position of the crankshaft at a time when the crankshaft starts rotating in a reverse direction;
setting a target rotational position within a range of the rotational position of the crankshaft between a time when an exhaust valve of one of the four cylinders that is in an expansion stroke when the crankshaft starts rotating in the reverse direction is opened and a time when the expansion stroke of the cylinder ends;
controlling a torque applying device to apply a positive rotational torque to the crankshaft when the predicted rotational position is behind the target rotational position; and
stopping application of the positive rotational torque from the torque applying device to the crankshaft at the time when the exhaust valve of the cylinder that is in the expansion stroke when the crankshaft starts rotating in the reverse direction is opened.

5. A driving method for a vehicle, comprising:
detecting, by a crank angle sensor, a rotational position of a crankshaft of an engine having four cylinders;
predicting a predicted rotational position based on the rotational position detected by the crank angle sensor when the engine is stopped, thereby controlling the rotational position of the crankshaft when the engine is stopped, the predicted rotational position being a rotational position of the crankshaft at a time when the crankshaft starts rotating in a reverse direction;
setting a target rotational position within a range of the rotational position of the crankshaft between a time when an exhaust valve of one of the four cylinders that is in an expansion stroke when the crankshaft starts rotating in the reverse direction is opened and a time when the expansion stroke of the cylinder ends;
controlling a torque applying device to apply a negative rotational torque to the crankshaft when the predicted rotational position is beyond the target rotational position; and
stopping application of the negative rotational torque from the torque applying device to the crankshaft when the crankshaft starts rotating in the reverse direction.

6. A non-transitory computer-readable medium that stores a program that causes a processor to perform a driving process for a vehicle, wherein the driving process includes:
detecting, by a crank angle sensor, a rotational position of a crankshaft of an engine having four cylinders;
predicting a predicted rotational position based on the rotational position detected by the crank angle sensor when the engine is stopped, thereby controlling the rotational position of the crankshaft when the engine is stopped, the predicted rotational position being a rotational position of the crankshaft at a time when the crankshaft starts rotating in a reverse direction;
setting a target rotational position within a range of the rotational position of the crankshaft between a time when an exhaust valve of one of the four cylinders that is in an expansion stroke when the crankshaft starts rotating in the reverse direction is opened and a time when the expansion stroke of the cylinder ends;
controlling a torque applying device to apply a positive rotational torque to the crankshaft when the predicted rotational position is behind the target rotational position; and
stopping application of the positive rotational torque from the torque applying device to the crankshaft at the time when the exhaust valve of the cylinder that is in the expansion stroke when the crankshaft starts rotating in the reverse direction is opened.

7. A non-transitory computer-readable medium that stores a program that causes a processor to perform a driving process for a vehicle, wherein the driving process includes:
detecting, by a crank angle sensor, a rotational position of a crankshaft of an engine having four cylinders;
predicting a predicted rotational position based on the rotational position detected by the crank angle sensor when the engine is stopped, thereby controlling the rotational position of the crankshaft when the engine is stopped, the predicted rotational position being a rotational position of the crankshaft at a time when the crankshaft starts rotating in a reverse direction;
setting a target rotational position within a range of the rotational position of the crankshaft between a time when an exhaust valve of one of the four cylinders that is in an expansion stroke when the crankshaft starts rotating in the reverse direction is opened and a time when the expansion stroke of the cylinder ends;
controlling a torque applying device to apply a negative rotational torque to the crankshaft when the predicted rotational position is beyond the target rotational position; and
stopping application of the negative rotational torque from the torque applying device to the crankshaft when the crankshaft starts rotating in the reverse direction.
